(19) United States
(12) Patent Application Publication
(10) Pub. No.: US 2012/0026968 A1
(43) Pub. Date: Feb. 2, 2012

(54) METHOD AND APPARATUS FOR TRIGGERING SCHEDULING INFORMATION REPORT IN MULTI-CARRIER SYSTEM

(75) Inventors: Liang QI, Beijing (CN); Fangli XU, Beijing (CN); Gao YAN, Beijing (CN)

(73) Assignee: CHINA ACADEMY OF TELECOMMUNICATIONS TECHNOLOGY, Beijing (CN)

(21) Appl. No.: 13/269,891

(22) Filed: Oct. 10, 2011

Related U.S. Application Data
(63) Continuation of application No. PCT/CN2010/071701, filed on Apr. 12, 2010.

(30) Foreign Application Priority Data
Apr. 10, 2009 (CN) 200910081805.2
Aug. 7, 2009 (CN) 200910165383.7

(51) Int. Cl. H04W 72/04

(52) U.S. Cl. 370/329

(57) ABSTRACT

The present invention provides methods and apparatus for triggering a SI report in a multi-carrier system, and the method includes: in a multi-carrier system, configuring a timer in UE corresponding to each carrier assigned to the UE, when a state of one of the carriers meets a preconfigured condition, starting or restarting the timer corresponding to the carrier, if the timer expires, triggering a SI report; or configuring a timer in UE corresponding to all carriers, when a state of one of the carriers meets a preconfigured condition, starting or restarting the second timer, if the second timer expires, triggering a SI report. The present invention provides technical solutions for triggering the SI report according to states of the carriers when there are multiple different carrier states, and thus the SI report is triggered in the multi-carrier system.

### FIELD OF THE INVENTION

The present invention relates to mobile communication technologies, and more particularly to a method and apparatus for triggering a scheduling information report in a multi-carrier system.

### BACKGROUND OF THE INVENTION

In 3GPP Release 7 communication standard of year 2007, an N frequency point characteristic is introduced to a High Speed Uplink Packet Access (HSUPA) system, that is, in the HSUPA system, one cell has multiple frequency points, one is a main frequency point, and the others are auxiliary frequency points. Currently, in the HSUPA system with the N frequency point characteristic, User Equipment (UE) works in a single carrier mode, and a work frequency point of the UE may be the main frequency point or auxiliary frequency point of the cell in which the UE is located.

Because of the introduced N frequency point characteristic, user capability of the HSUPA system is greatly improved. Meanwhile, the UE can use the carrier at multiple frequency points, which provides basis for introducing multi-carrier characteristic in the HSUPA system. If the multi-carrier characteristic is introduced in the HSUPA system, uplink peak rate of the user will be increased to be close to downlink peak rate. Therefore, it can be forecasted that the multi-carrier characteristic of the HSUPA system will be introduced in the 3GPP standard soon.

Compared with the HSUPA system of the single carrier, if the multi-carrier characteristic is introduced in the HSUPA system, many problems related to the multi-carrier are brought, such as how to trigger a SI report. Network side assigns resources to the UE according to the SI reported by the UE.

In the conventional HSUPA system of the signal carrier, there are 6 triggering conditions in the SI report, and the SI report will be triggered when one of the triggering conditions is met. The 6 conditions respectively are:

condition 1: a Radio Link Control (RLC) buffer of the UE changes from 0 to a value larger than 0, in other words, the UE has data to be sent currently while there is no data to be sent before;

condition 2: the UE is in a switch procedure, and the RLC buffer is not null;

condition 3: a wait timer (T-WAIT) expires; when a scheduling grant obtained by the UE expires and the buffer is not null, the UE starts the T-WAIT; if the UE obtains the scheduling grant again when the T-WAIT is running, the T-WAIT is restarted when the UE obtains the scheduling grant again. The T-WAIT is used to avoid that the UE is not scheduled for a long time;

If the SI report is triggered by the condition 3, an Enhanced Dedicated Channel (E-DCH) Random access Uplink Control Channel (E-RUCCH) is used to report the SI;

condition 4: a SI report timer (T-SI) expires; every time the UE reports the SI through a Media Access Control layer Protocol Data Unit on E-DCH (MAC-e PDU or MAC-i PDU), the T-SI is started or restarted; the T-SI is used to make the UE report the SI in time;

If the SI report is triggered by the condition 4, the MAC-c PDU or MAC-i PDU is used to report the SI;

condition 5: besides logic channel data, if the SI can be filled in remained space of a Transport Block Size (TBS) selected by an E-DCH Transport Format Combination (E-TFC) of the UE, the SI report is triggered, and the SI is reported through the MAC-e PDU or MAC-i PDU corresponding to the TBS;

condition 6: if logic channel data with a priority higher than a priority of logic channel data currently stored by the UE comes into the RLC buffer of the UE, the SI report is triggered, and the UE reports the SI through the MAC-e PDU or MAC-i PDU.

Conditions 1 and 2 relate to a grant request triggering, conditions 3 and 4 relates to a timer triggering, condition 5 relates to a padding triggering and condition 6 relates to higher priority data triggering.

Whether conditions 1, 2 and 5 are met depend on parameters of the UE, specifically, the condition 1 depends on the buffer state of the UE, the condition 2 depends on the switch state and buffer state of the UE, the condition 5 depends on the padding state of the TBS. Whether condition 3, 4, and 6 are met depend on state of the carrier of the UE, specifically, the condition 3 corresponds to the scheduling grant state of the carrier of the UE, the condition 4 corresponds to the state of sending the MAC-e PDU or MAC-i PDU by the carrier of the UE, and condition 6 corresponds to state of the priority of the logic channel data newly received by the carrier of the UE.

In communication systems of the single carrier, whether condition 3, 4, and 6 are met depend on the state of the carrier currently used by the UE. If the multi-carrier characteristic is introduced in a mobile communication system, the number of the carriers assigned to the UE by the network side changes from one to multiple, accordingly, the UE has multiple carrier states. Therefore, when there are multiple different carrier states, how to trigger the SI report is a problem must be solved when the multi-carrier characteristic is introduced in the 3GPP standard. In the multi-carrier system, the network side needs to assign resources to each carrier of the UE according to the SI reported by the UE, and the resources assigned to the carriers may be the same or different.

Currently, the multi-carrier characteristic is not introduced in the 3GPP standard, and there is no solution corresponds to how to trigger the SI report in the multi-carrier communication system.

### SUMMARY OF THE INVENTION

Embodiments of the present invention provide a method for triggering SI report in a multi-carrier system so that the UE can trigger the SI report in the multi-carrier system.

Embodiments of the present invention are implemented as follows.

A method for triggering SI report in a multi-carrier system, applied in a multi-carrier system, includes:

configuring a timer in User Equipment (UE) corresponding to all carriers assigned to the UE, when a state of one of the carriers meets a preconfigured condition, starting or restarting the timer, if the timer expires, triggering a SI report.

A method for triggering SI report in a multi-carrier system, applied in a multi-carrier system, includes:

configuring a timer in User Equipment (UE) corresponding to each carrier assigned to the UE, when a state of one of the carriers meets a preconfigured condition, starting or restarting the timer corresponding to the carrier, if the timer expires, triggering a SI report.

An apparatus for triggering SI report in a multi-carrier system includes: a SI report triggering module and one timing module, wherein

the timing module corresponds to all carriers assigned to the apparatus, when a state of one of the carriers meets a preconfigured condition, the timing module is started or restarted, if the timing module expires, a triggering instruction is send to the SI report triggering module;

the SI report triggering module is adapted to receive the trigging instruction, and trigger a SI report.

As can be seen from the above solutions, in the embodiments of the present invention, a timer is configured for each carrier assigned to the UE by the network side, or a timer is configured for all carriers assigned to the UE by the network side, the timer is start or restart according to a preconfigured condition, if the timer expires, the SI report is triggered. In the embodiments of the present invention, how to trigger the SI report according to carrier states when there are multiple different carrier states is defined in the case that each timer is maintained for each carrier or one timer is maintained for all the carriers. Specifically, if each timer is maintained for each carrier, the SI report is triggered independently according to the state of each carrier; if one timer is maintained for all the carriers, the SI report is triggered when any one of the carriers assigned to the UE by network side meets a preconfigured condition.

If the UE triggers the SI report independently according to the state of each carrier, i.e. each first timer is maintained for each carrier, the SI report is triggered when the first timer expires, and thus the SI is reported in time, which is good for the communication system to schedule each UE and assign recourses to each carrier of the UE.

If the SI report is triggered when any one of the carriers assigned to the UE by the network side meets a preconfigured condition, i.e. the second timer is maintained, the SI report is triggered when the second timer expires, if the second timer is the T-WAIT, the using frequency of the E-RUCCH is reduced, collision probability of using the E-RUCCH channel by the UE is reduced, and success rate of enhanced random access of the UE is improved; if the second timer is the T-SI, the MAC-e PDU or MAC-i PDU may be used to carry all SI respectively maintained by each carrier or carry the SI maintained by all carriers, and thus it is unnecessary to trigger the SI report according the state of each carrier, and the system resources are saved. In the present invention, how to maintain the SI respectively by each carrier or how to maintain the SI by all the carriers is not discussed.

In addition, if the SI report is triggered by maintaining the second timer, data transmitted when reporting the SI is reduced and thus the system resources are saved. Specifically, some resource information in the SI of different carriers of each UE is the same, such as the RLC storage space, and some resource information in the SI of different carriers is different, such as UE Power Headroom, (UPH), and usually the same resource information changes fast while the different resource information changes slowly, and thus if the SI report is triggered by maintaining the second timer, every time the SI is reported, no matter that the SI corresponds to different carrier, the same resource information is carried, and thus fast update of the same resource information is ensured, and the data transmission quantity is reduced compared with that the first timer is maintained for trigger the SI report.

### BRIEF DESCRIPTION OF THE DRAWINGS

FIG. 1 is a flowchart illustrating a method for triggering a SI report when each carrier in a UE side independently maintains a T-WAIT respectively.

FIG. 2 is a flowchart illustrating a method for triggering a SI report when each carrier independently maintains a T-SI respectively.

FIG. 3 is a flowchart illustrating a method for triggering a SI report when carriers maintain a T-WAIT.

FIG. 4 is a flowchart illustrating a method for triggering a SI report when carriers maintain a T-SI.

FIG. 5 is a schematic diagram illustrating a first structure of an apparatus for triggering a SI report in a multi-carrier system according to an embodiment of the present invention.

FIG. 6 is a schematic diagram illustrating a second structure of an apparatus for triggering a SI report in a multi-carrier system according to an embodiment of the present invention.

FIG. 7 is a schematic diagram illustrating a third structure of an apparatus for triggering a SI report in a multi-carrier system according to an embodiment of the present invention.

### DETAILED DESCRIPTION OF THE INVENTION

In order to make the object, technical solution and merits of the present invention clearer, the present invention will be illustrated in detail hereinafter with reference to the accompanying drawings and embodiments.

In the embodiments of the present invention, when there are multiple different carriers in the user side, how to trigger the SI report according to carrier states is defined. Specifically, the SI report may be independently triggered respectively according to the state of each carrier assigned to the UE by the network side (“the carrier assigned to the UE by the network side” is called as “the configured carrier of the UE” for short hereinafter), or the SI report may be triggered when the states of all the carriers meet a preconfigured condition. In the embodiments of the present invention, the state of the carrier is monitored by using a timer, if the SI report is independently triggered respectively according to the state of each carrier, a first timer is configured for each configured carrier of the UE to monitor the state of the configured carrier; if the SI report is triggered when the states of all the carriers meet a preconfigured condition, a second timer is configured for all the configured carriers of the UE to monitor the states of the carriers.

The first timer may be the T-WAIT or T-SI, the second timer may also be the T-WAIT or T-SI, and the embodiments of the present invention may be described in detail hereinafter.

The SI triggered by the T-SI is carried by the MAC PDU. Specifically, the SI may be carried by the MAC-e PDU or MAC-i PDU. The MAC-i PDU is enhanced from the MAC-e PDU and is only used as the MAC PDU that carries the SI in the present invention. In the future evolution system, other MAC PDU may be evolved from the MAC-e PDU or MAC-i PDU, when the embodiments of the present invention are applied in the future evolution system, the other MAC PDU may be used to carry the SI. The procedures of carrying the SI by different MAC PDUs do no have essential difference, and thus in the following embodiments, the MAC-e PDU is taken as an example.

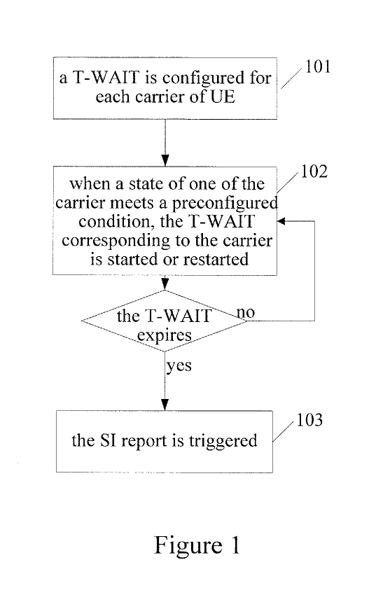

FIG. 1 is a flowchart illustrating a method for triggering a SI report when each carrier in a UE side independently maintains a T-WAIT respectively. As shown in FIG. 1, the method includes the following processes.

Step 101, a T-WAIT is configured for each configured carrier of UE respectively.

Step 102, when a state of one of the configured carrier meets a preconfigured condition, the T-WAIT corresponding to the configured carrier is started or restarted, if the T-WAIT expires, step 103 is performed, otherwise, step 102 is returned.

In this step, if a scheduling grant currently obtained by the carrier corresponding to the T-WAIT expires, the T-WAIT is started or restarted; and if the carrier corresponding to the T-WAIT obtains the scheduling grant again when the T-WAIT is running, the T-WAIT stops running or/and is reset.

Step 103, the SI report is triggered.

In this step, the SI is reported via an enhanced random access procedure initiated on E-RUCCH resources of the carrier corresponding to the expired T-WAIT.

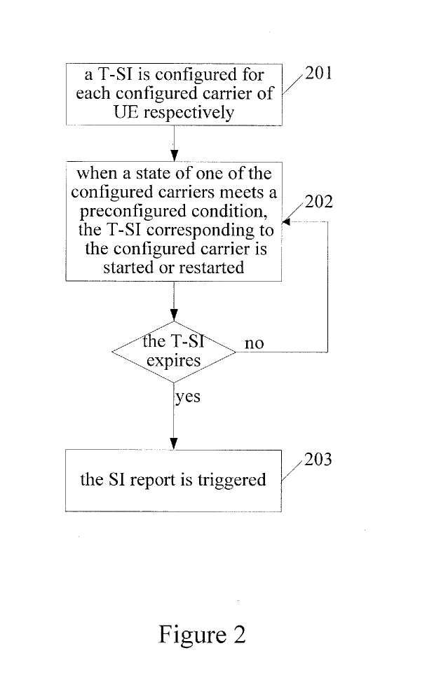

FIG. 2 is a flowchart illustrating a method for triggering a SI report when each carrier independently maintains a T-SI respectively. As shown in FIG. 2, the method includes the following processes.

Step 201, a T-SI is configured for each configured carrier of UE respectively.

Step 202, when a state of one of the configured carrier meets a preconfigured condition, the T-SI corresponding to the configured carrier is started or restarted, if the T-SI expires, step 203 is performed, otherwise, step 202 is returned.

In this step, the T-SI is started or restarted every time after the SI is reported via the MAC-e PDU by the carrier corresponding to the T-SI.

Step 203, the SI report is triggered.

In this step, the SI is reported through the MAC-e PDU of the carrier corresponding to the expired T-SI.

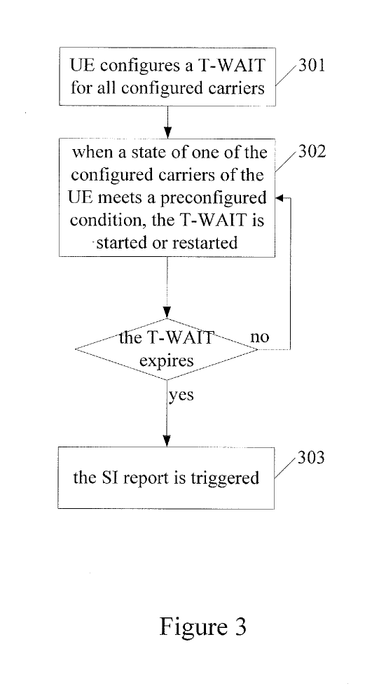

FIG. 3 is a flowchart illustrating a method for triggering a SI report when carriers maintain a T-WAIT. As shown in FIG. 3, the method includes the following processes.

Step 301, UE configures one T-WAIT for all configured carriers of the UE.

Step 302, when a state of one of the configured carriers of the UE meets a preconfigured condition, the T-WAIT is started or restarted, if the T-WAIT expires, step 303 is performed, otherwise, step 302 is returned.

In this step, if a scheduling grant currently obtained by one of all the carriers expires, the T-WAIT is started or restarted; and if one of all the carriers obtains the scheduling grant when the T-WAIT is running, the T-WAIT stops running or/and is reset.

Step 303, the SI report is triggered.

In this step, the SI is reported via an enhanced random access procedure initiated on E-RUCCH resources configured for the UE by the network side after the T-WAIT expires at step 302.

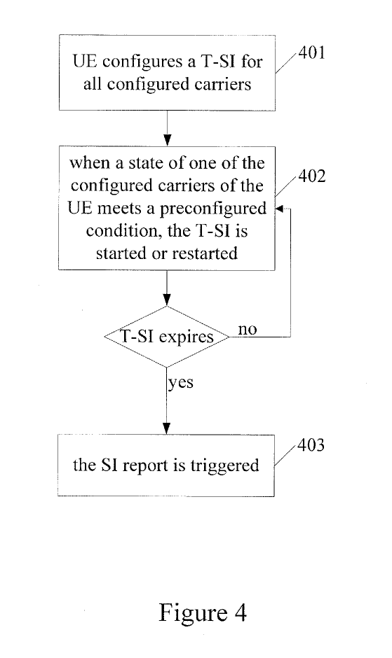

FIG. 4 is a flowchart illustrating a method for triggering a SI report when carriers maintain a T-SI. As shown in FIG. 4, the method includes the following processes.

Step 401, UE configures one T-SI for all configured carriers of the UE.

Step 402, when a state of one of the configured carriers of the UE meets a preconfigured condition, the T-SI is started or restarted, if the T-SI expires, step 403 is performed, otherwise, step 402 is returned.

In this step, the T-SI is started or restarted every time after the SI is reported via the MAC-e PDU by one of the carriers, and the T-SI starts running until the T-SI expires or is started or restarted again.

Step 403, the SI report is triggered.

In this step, the SI is reported by the carrier firstly obtaining the scheduling grant after the T-SI expires at step 402, so that the SI is reported in time.

FIGS. 1 to 4 provide the specific methods in which the T-WAIT or T-SI is maintained for each configured carrier of the UE or for all the configured carriers of the UE, in practical applications, the T-WAIT and the T-SI work independently and do not affect each other, and thus in the same multi-carrier mobile communication system, the UE may maintain the T-WAIT and T-SI for each configured carrier independently, or maintain the T-WAIT and T-SI for all the configured carriers, or maintain the T-WAIT for each configured carrier independently and maintain the T-SI for all the configured carriers, or maintain the T-SI for each configured carrier independently and maintain the T-WAIT for all the configured carriers. For any one of the above methods, modules may be configured in an apparatus to trigger the SI report according to any one of the above methods.

Besides the SI report triggered according to the state of each carrier, the SI report may also be triggered according to priority state of logic channel data newly received by the UE. Specifically, if the logic channel data with a priority higher than a priority of logic channel data currently stored by the UE is received by the UE, the SI is reported by the UE via a carrier firstly obtaining a scheduling grant after receiving the logic channel data with the higher priority.

The embodiments of the present invention are applicable to mobile communication systems in which there are multiple carriers and the UE needs to report the SI information to the network side, for example, multi-carrier HSUPA systems, HSPA subsequence evolution systems.

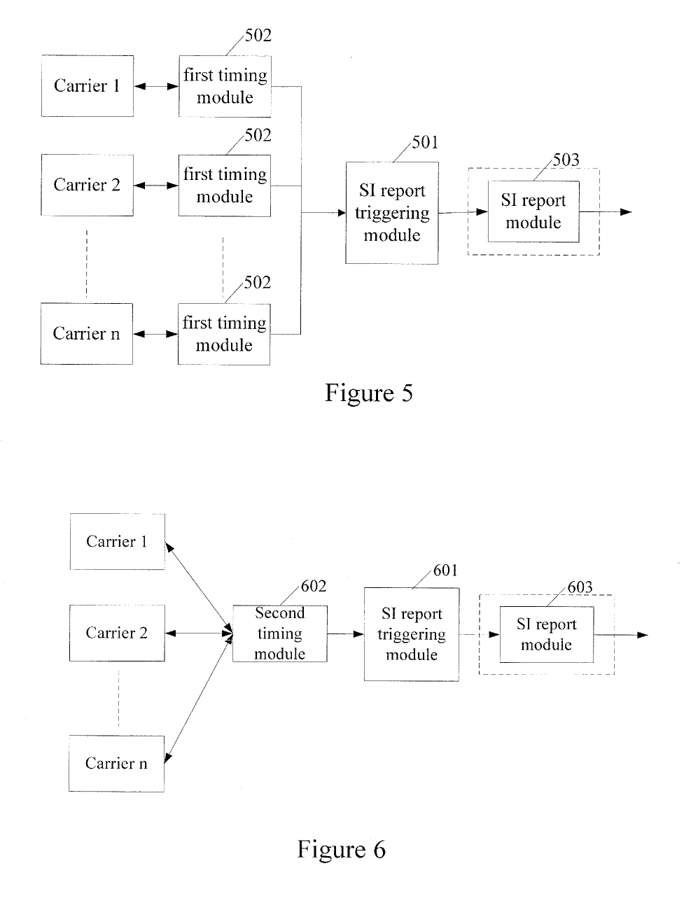

FIG. 5 is a schematic diagram illustrating a first structure of an apparatus for triggering a SI report in a multi-carrier system according to an embodiment of the present invention. As shown in FIG. 5, the apparatus includes a SI report triggering module 501 and at least two first timing modules 502.

Each first timing module 502 corresponds to one carrier assigned to the apparatus by network side, when a state of the carrier meets a preconfigured condition, the first timing module 502 is started or restarted, if the first timing module 502 expires, a triggering instruction is send to the SI report triggering module 501.

The SI report triggering module 501 is adapted to receive the trigging instruction, and trigger a SI report.

If the first timing module 502 is a T-WAIT,

if a scheduling grant currently obtained by the carrier corresponding to the T-WAIT expires, the T-WAIT is started or restarted; and, if the carrier corresponding to the T-WAIT obtains the scheduling grant when the T-WAIT is running, the T-WAIT stops running or/and is reset.

The apparatus further includes a SI report module 503.

The SI report module 503 is adapted to, according to the triggering of SI report triggering module 501, report the SI via an enhanced random access procedure initiated on E-RUCCH resources of the carrier corresponding to the expired T-WAIT.

If the first timing module 502 is a T-SI,

the T-SI is started or restarted every time after the carrier corresponding to the T-SI reports the SI via the MAC-e PDU; The SI report module 503 is adapted to, according to the triggering of SI report triggering module 501, report the SI via a new MAC-e PDU of the carrier corresponding to the expired T-SI.

FIG. 6 is a schematic diagram illustrating a second structure of an apparatus for triggering a SI report in a multi-carrier system according to an embodiment of the present invention. As shown in FIG. 6, the apparatus includes a SI report triggering module 601 and one second timing module 602.

The second timing module 602 corresponds to all carriers assigned to the apparatus by network side, when a state of any one of the carriers meets a preconfigured condition, the second timing module 602 is started or restarted, if the second timing module 602 expires, a triggering instruction is send to the SI report triggering module 601.

The SI report triggering module 601 is adapted to receive the trigging instruction, and trigger a SI report.

If the second timing module 602 is a T-WAIT,

if a scheduling grant currently obtained by one of the carriers expires, the T-WAIT is started or restarted; and if one of the carriers obtains the scheduling grant when the T-WAIT is running, the T-WAIT stops running or/and is reset.

The apparatus shown in FIG. 6 further includes a SI report module 603.

The SI report module 603 is adapted to, according to the triggering of SI report triggering module 601, report the SI via an enhanced random access procedure initiated on E-RUCCH resources corresponding to the carrier firstly obtaining the scheduling grant after the T-WAIT expires.

If the second timing module 602 is a T-SI,

the T-SI is started or restarted every time after any one of the carriers reports the SI via the MAC-e PDU; The SI report module 603 is adapted to, according to the triggering or the SI report triggering module 601, report the SI via a new MAC-e PDU of the carrier firstly obtaining the scheduling grant after the T-SI expired.

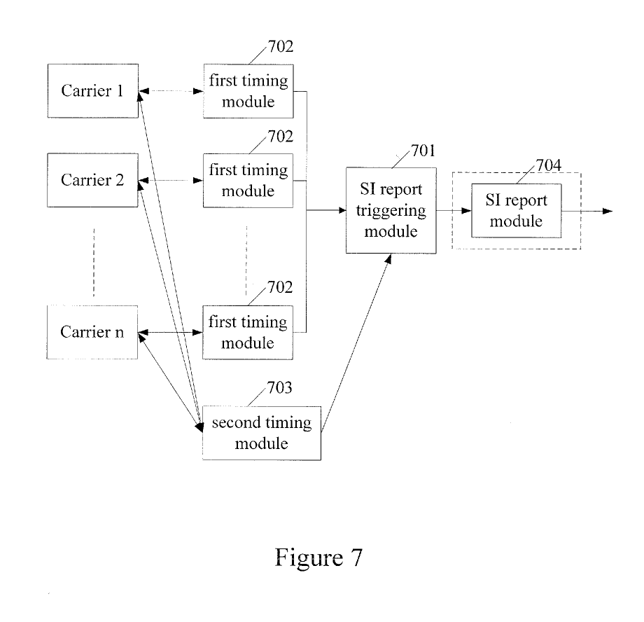

FIG. 7 is a schematic diagram illustrating a third structure of an apparatus for triggering a SI report in a multi-carrier system according to an embodiment of the present invention. As shown in FIG. 7, the apparatus includes a SI report triggering module 701, at least two first timing modules 702 and one second timing module 702.

Each first timing module 702 corresponds to one carrier assigned to the apparatus by network side, when a state of the carrier meets a preconfigured condition, the first timing module 702 is started or restarted, if the first timing module 702 expires, a triggering instruction is send to the SI report triggering module 701.

The second timing module 703 corresponds to all carriers assigned to the apparatus by the network side, when a state of any one of the carriers meets a preconfigured condition, the second timing module 703 is started or restarted, if the second timing module 703 expires, a triggering instruction is send to the SI report triggering module 701.

The SI report triggering module 701 is adapted to receive the trigging instruction, and trigger a SI report.

If the first timing module 702 is a T-WAIT,

if a scheduling grant currently obtained by the carrier corresponding to the T-WAIT expires, the T-WAIT is started or restarted; and if the carrier corresponding to the T-WAIT obtains the scheduling grant when the T-WAIT is running, the T-WAIT stops running or/and is reset.

The apparatus further includes a SI report module 704.

the SI report module 704 is adapted to, according to the triggering of SI report triggering module 701, report the SI via an enhanced random access procedure initiated on E-RUCCH resources of the carrier corresponding to the expired T-WAIT.

If the first timing module 702 is a T-SI,

the T-SI is started or restarted every time after the carrier corresponding to the T-SI reports the SI via the MAC-e PDU; The SI report module 704 is adapted to, according to the triggering of SI report triggering module 701, report the SI via a new MAC-e PDU of the carrier corresponding to the expired T-SI.

If the second timing module 703 is a T-WAIT,

if a scheduling grant currently obtained by one of the carriers expires, the T-WAIT is started or restarted; and if one of the carriers obtains the scheduling grant when the T-WAIT is running, the T-WAIT stops running or/and is reset.

The SI report module 704 is adapted to, according to the triggering of SI report triggering module 701, report the SI via an enhanced random access procedure initiated on E-RUCCH resources corresponding to the carrier firstly obtaining the scheduling grant after the T-WAIT expires

If the second timing module 702 is a T-SI,

The T-SI is started or restarted every time after any one carrier of the carriers reports the SI via the MAC-e PDU; The SI report module 704 is adapted to, according to the triggering of SI report triggering module 701, report the SI via a new MAC-e PDU of the carrier firstly obtaining the scheduling grant after the T-SI expired.

The foregoing are only preferred embodiments of the present invention and are not for use in limiting the protection scope of the present invention. Any modification, equivalent replacement and improvement made within the scope of the present invention should be covered under the protection scope of the present invention.

1. A method for triggering a scheduling information (SI) report in a multi-carrier system, comprising:
configuring a timer in User Equipment (UE) corresponding to all carriers assigned to the UE, when a state of one of the carriers meets a preconfigured condition, starting or restarting the timer, if the timer expires, triggering a SI report.

2. The method of claim 1, wherein the timer comprises a wait timer (T-WAIT);
when a state of one of the carriers meets a preconfigured condition, starting or restarting the timer comprises:
if a scheduling grant currently obtained by one of the carriers expires, starting or restarting the T-WAIT; and if one of the carriers of the UE obtains the scheduling grant when the T-WAIT is running, stopping and/or resetting the T-WAIT.

3. The method of claim 2, wherein triggering a SI report comprises:
reporting the SI via an enhanced random access procedure initiated on E-RUCCH resources configured for the UE after the T-WAIT expires.

4. The method of claim 1, wherein the timer comprises a SI report timer (T-SI);
when a state of one of the carriers meets a preconfigured condition, starting or restarting the timer corresponding to the carrier comprises:
starting or restarting the T-SI after one of the carriers reports the SI through a MAC PDU.

5. The method of claim 2, wherein the timer comprises a SI report timer (T-SI);
when a state of one of the carriers meets a preconfigured condition, starting or restarting the timer corresponding to the carrier comprises:
starting or restarting the T-SI after one of the carriers reports the SI through a MAC PDU.

6. The method of claim 4, wherein the MAC PDU comprises a MAC-e PDU or a MAC-i PDU.

7. The method of claim 4, wherein triggering a SI report comprises:
reporting, by the UE, the SI via the MAC PDU of the carrier firstly obtaining a scheduling grant after the T-SI expires.

8. The method of claim 1, further comprising:
if the logic channel data with a priority higher than a priority of logic channel data currently stored by the UE is received by the UE, reporting, by the UE, the SI via a carrier firstly obtaining a scheduling grant after receiving the logic channel data with the higher priority.

9. An apparatus for triggering a scheduling information (SI) report in a multi-carrier system, comprising: a SI report triggering module and one timing module, wherein
the timing module corresponds to all carriers assigned to the apparatus, when a state of one of the carriers meets a preconfigured condition, the timing module is started or restarted, if the timing module expires, a triggering instruction is send to the SI report triggering module;
the SI report triggering module is adapted to receive the trigging instruction, and trigger a SI report.

10. The apparatus of claim 9, wherein the timing module comprises a T-WAIT,
if a scheduling grant currently obtained by one of the carriers expires, the T-WAIT is started or restarted; and if one of the carriers obtains the scheduling grant when the T-WAIT is running, the T-WAIT stops running and/or is reset.

11. The apparatus of claim 10, further comprising a SI report module; wherein
the SI report module is adapted to, according to the triggering of SI report triggering module, report the SI via an enhanced random access procedure initiated on E-RUCCH resources configured for the UE after the T-WAIT expires.

12. The apparatus of claim 9, wherein the timing module comprises a T-SI,
the T-SI is started or restarted after one of the carriers reports the SI through a MAC PDU.

13. The apparatus of claim 10, wherein the timing module comprises a T-SI,
the T-SI is started or restarted after one of the carriers reports the SI through a MAC PDU.

14. The method of claim 12, wherein the MAC PDU comprises a MAC-e PDU or a MAC-i PDU.

15. The apparatus of claim 12, further comprising a SI report module; wherein
the SI report module is adapted to, according to the triggering of SI report triggering module, report the SI via the MAC PDU of the carrier firstly obtaining the scheduling grant after the T-SI expired at this time.

16. A method for triggering a scheduling information (SI) report in a multi-carrier system, comprising:
configuring a timer in User Equipment (UE) corresponding to each carrier assigned to the UE, when a state of one of the carriers meets a preconfigured condition, starting or restarting the timer corresponding to the carrier, if the timer expires, triggering a SI report.

17. The method of claim 16, wherein the timer comprises a wait timer (T-WAIT);
when a state of one of the carriers meets a preconfigured condition, starting or restarting the timer corresponding to the carrier comprises:
if a scheduling grant currently obtained by the carrier corresponding to the T-WAIT expires, starting or restarting the T-WAIT; and if the carrier corresponding to the T-WAIT obtains the scheduling grant when the T-WAIT is running, stopping and/or resetting the T-WAIT; and
triggering a SI report comprises:
after the T-WAIT corresponding to one of the carriers expires, reporting the SI via an enhanced random access procedure initiated on E-RUCCH resources corresponding to the carrier.

18. The method of claim 16, wherein the timer comprises a SI report timer (T-SI);
when a state of one of the carriers meets a preconfigured condition, starting or restarting the timer corresponding to the carrier comprises:
starting or restarting the T-SI after the carrier corresponding to the T-SI reports the SI through a MAC PDU.

19. The method of claim 17, wherein the timer comprises a SI report timer (T-SI);
when a state of one of the carriers meets a preconfigured condition, starting or restarting the timer corresponding to the carrier comprises:
starting or restarting the T-SI after the carrier corresponding to the T-SI reports the SI through a MAC PDU.

20. The method of claim 18, wherein triggering a SI report comprises:
after the T-SI corresponding to one of the carriers of the UE expires, reporting, by the UE, the SI via the MAC PDU corresponding to the carrier.
